(19) United States
(12) Patent Application Publication
(10) Pub. No.: US 2012/0258358 A1
(43) Pub. Date: Oct. 11, 2012

(54) CATHODE ACTIVE MATERIAL FOR A LITHIUM ION SECONDARY BATTERY AND A LITHIUM ION SECONDARY BATTERY

(75) Inventors: Yukinobu YURA, Nagoya-City (JP); Chiori Ito, Nagoya-City (JP); Ryuta Sugiura, Toyohashi-City (JP); Nobuyuki Kobayashi, Nagoya-City (JP)

(73) Assignee: NGK Insulators, Ltd., Nagoya-City (JP)

(21) Appl. No.: 13/334,617

(22) Filed: Dec. 22, 2011

Related U.S. Application Data
(60) Provisional application No. 61/472,805, filed on Apr. 7, 2011.
(60) Provisional application No. 61/496,721, filed on Jun. 14, 2011.
(60) Provisional application No. 61/527,306, filed on Aug. 25, 2011.
(60) Provisional application No. 61/537,763, filed on Sep. 22, 2011.

(51) Int. Cl. H01M 4/02; H01M 10/052

(52) U.S. Cl. 429/209

(57) ABSTRACT

[Summary] Provided is a cathode active material for a lithium secondary battery having a layered rock salt structure, including a secondary grain formed of a large number of primary grains each having an average grain size of 0.01 μm or more and 5 μm or less, in which the secondary grain has the following characteristics: a (003) plane orientation degree of 60% or more; an average grain size of 1 μm or more and 100 μm or less; an aspect ratio of 1.0 or more and less than 2; a voidage of 3% or more and 30% or less; an average pore size of 0.1 μm or more and 5 μm or less; and a value obtained by dividing the average grain size of each of the primary grains by the average pore size of 0.1 or more and 5 or less.

### TECHNICAL FIELD

The present invention relates to a cathode active material for a lithium secondary battery having a layered rock salt structure. The present invention also relates to a lithium battery using such cathode active material.

### BACKGROUND ART

A cathode active material using a lithium composite oxide (lithium transition metal oxide) having a layered rock salt structure is widely known as a cathode active material for a lithium secondary battery (sometimes referred to as “lithium ion secondary battery”) (see, for example, Japanese Patent Application Laid-open No. Hei 5-226004 and Japanese Patent Application Laid-open No. 2003-132887).

In a cathode active material of this type, it is known that diffusion of lithium ions (Li⁺) in the cathode active material occurs in an in-plane direction of a (003) plane (i.e., any direction in a plane parallel with the (003) plane), and intercalation and deintercalation of lithium ions occur through a crystal plane other than the (003) plane (e.g., a (101) plane or a (104) plane).

In view of the foregoing, in the cathode active material of this type, an attempt has been made to improve cell characteristics of a lithium secondary battery by means of exposure of a crystal plane through which intercalation and deintercalation of lithium ions satisfactorily occur (plane other than the (003) plane: e.g., the (101) plane or the (104) plane) on a surface to be more frequently brought into contact with an electrolyte (see, for example, International Patent WO20101074304A).

Further, in the cathode active material of this type, there is known one having formed therein pores (also referred to as “cavity” or “void”) (see, for example, Japanese Patent Application Laid-open No. 2002-75365, Japanese Patent Application Laid-open No. 2004-083388, and Japanese Patent Application Laid-open No. 2009-117241).

### SUMMARY OF THE INVENTION

In a lithium secondary battery, there is a demand for additional improvements in cell characteristics, in particular, a discharge voltage at a high rate (hereinafter, simply referred to as “output characteristic”) and a discharge capacity at a high rate (hereinafter, simply referred to as “rate characteristic”). The present invention has been made to provide a cathode active material of this type having additionally improved characteristics as compared to a conventional one.

A cathode active material for a lithium secondary battery according to the present invention (hereinafter, referred to as “cathode active material of the present invention” or simply referred to as “cathode active material”) has a layered rock salt structure and includes the following features.
(1) The cathode active material contains a secondary grain formed of a large number of primary grains each having an average grain size of 0.01 μm or more and 5 μm or less.
(2) The secondary grain includes the following features.
   A (003) plane orientation degree of 60% or more (preferably 75% or more).
   An average grain size of 1 μm or more and 100 μm or less.
   An aspect ratio, which is a value obtained by dividing a long axis size by a short axis size, of 1.0 or more and less than 2.
   A voidage of 3% or more and 30% or less.
   An average pore size of 0.1 μm or more and 5 μm or less.
   A value obtained by dividing the average grain size of each of the primary grains by the average pore size of 0.1 or more and 5 or less.

Further, a lithium secondary battery according to the present invention includes a cathode including a cathode active material layer and an anode including an anode active material layer. In addition, in the lithium secondary battery according to the present invention, the cathode active material layer contains the cathode active material formed as the secondary grain including an assembly of a plurality of the primary grains (monocrystalline primary grains of a lithium composite oxide having a layered rock salt structure).

As used herein, the “layered rock salt structure” refers to a crystal structure in which lithium layers and layers of a transition metal other than lithium are stacked in alternating layers with an oxygen layer therebetween (typically α-NaFeO₂ type structure: cubic rock salt type structure in which a transition metal and lithium are arrayed orderly in the direction of the [111] axis).

Lithium cobaltate (LiCoO₂) may be typically used as the lithium composite oxide having a layered rock salt structure for constituting the cathode active material of the present invention. As a matter of course, a solid solution containing, for example, nickel or manganese in addition to cobalt may also be used as the lithium composite oxide for constituting the cathode active material of the present invention. Specifically, lithium nickelate, lithium manganate, lithium nickel manganate, lithium nickel cobaltate, lithium cobalt nickel manganate, lithium cobalt manganate, or the like may be used as the lithium composite oxide for constituting the cathode active material of the present invention. Each of those materials may further contain one or more kinds of elements such as Mg, Al, Si, Ca, Ti, V, Cr, Fe, Cu, Zn, Ga, Ge, Sr, Y, Zr, Nb, Mo, Ag, Sn, Sb, Te, Ba, and Bi.

Specifically, for example, as the lithium composite oxide for constituting the cathode active material of the present invention, there may be utilized one represented by each of the following composition formulae.

LiₚMeO₂ Composition Formula (1)

(In the composition formula (1): a relationship of 0.9≦p≦1.3 is satisfied; and Me represents at least one kind of metal element selected from the group consisting of Mn, Ti, V, Cr, Fe, Co, Ni, Cu, Al, Mg, Zr, B, and Mo.)

xLi₂MO₃-(1-x)LiₚMeO₂ Composition Formula (2)

(In the composition formula (2): relationships of 0<x<1 and 0.9≦p≦1.3 are satisfied; and M and Me each independently represent at least one kind of metal element selected from the group consisting of Mn, Ti, V, Cr, Fe, Co, Ni, Cu, Al, Mg, Zr, B, and Mo.)

“Me” in each of the composition formulae (1) and (2) has only to represent at least one kind of metal element having an average oxidation state of “+3” and preferably represents at least one kind of metal element selected from the group consisting of Mn, Ni, Co, and Fe. Further, “M” in the composition formula (2) has only to represent at least one kind of metal element having an average oxidation state of “+4” and preferably represents at least one kind of metal element selected from the group consisting of Mn, Zr, and Ti.

Further, a cathode active material of a nickel-cobalt-aluminum system to be suitably used in the present invention has a composition represented by the following general formula.

Liₚ(Niₓ, Co_{y}, Al_{z})O₂ General formula

(In the general formula, relationships of 0.9≦p≦1.3, 0.6<x≦0.9, 0.05≦y≦0.25, 0≦z≦0.2, and x+y+z=1 are satisfied.)

In the general formula, the preferred range of p is 0.9≦p≦1.3 and the more preferred range thereof is 1.0≦p≦1.1. A case where p represents less than 0.9 is not preferred because a reduction in discharge capacity occurs. On the other hand, a case where p represents 1.3 or more is not preferred because a reduction in discharge capacity and an increase in amount of a gas generated in a battery during charge occur.

Further, a case where x represents less than 0.6 in the general formula is not preferred because a reduction in discharge capacity occurs. On the other hand, a case where x represents more than 0.9 is not preferred because a reduction in stability occurs. It is preferred that x falls within the range of 0.7 to 0.85.

Further, a case where y represents 0.05 or less in the general formula is not preferred because a crystal structure becomes unstable. On the other hand, a case where y represents more than 0.25 is not preferred because a reduction in discharge capacity occurs. It is preferred that y falls within the range of 0.10 to 0.20.

Further, a case where z represents more than 0.2 in the general formula is not preferred because a reduction in discharge capacity occurs. It is preferred that z falls within the range of 0.01 to 0.1.

The “primary grain” refers to a grain present singly without forming any aggregate. In particular, the “monocrystalline primary grain” refers to the primary grain having no grain boundary therein. On the other hand, an aggregate of the primary grains or an assembly of a plurality of (a large number of) the monocrystalline primary grains is referred to as “secondary grain.”

The “average grain size” refers to an average of diameters of grains. Such “diameter” is typically, in the case of assuming a grain of interest to be a sphere having the same volume or the same cross-sectional area as the grain, a diameter of the sphere. It should be noted that the “average” is suitably one calculated on a number basis. The average grain size of the primary grain may be determined, for example, by observing a surface or a cross-section of the secondary grain with a scanning electron microscope (SEM).

The “(003) plane orientation degree” refers to a ratio of (003) plane orientation in the secondary grain expressed in terms of a percentage. That is, a (003) plane orientation degree of 60% in the secondary grain means that 60% of a large number of (003) planes ((003) planes in a layered rock salt structure) contained in the secondary grain are parallel with each other. It can therefore be said that, as a value for the rate becomes higher, a degree of (003) plane orientation in the secondary grain becomes higher (specifically, a large number of the primary grains which are monocrystalline for constituting the secondary grain are provided so that the respective (003) planes are parallel with each other to the greatest possible extent). On the other hand, it can be said that, as the value becomes lower, a degree of (003) plane orientation in the secondary grain becomes lower (specifically, a large number of the primary grains which are monocrystalline for constituting the secondary grain are provided so that the respective (003) planes are in “random” directions).

It should be noted that the secondary grain contains a large number of the primary grains as described above. In addition, the primary grains are monocrystalline, and hence a rate of orientation of the primary grains themselves has no importance. In view of the foregoing, from the viewpoint of regarding a state of orientation of a large number of the primary grains in the secondary grain as a state of (003) plane orientation of the entire secondary grain, the (003) plane orientation degree in the secondary grain may also be referred to as “(003) plane orientation degree of the primary grains in the secondary grain.”

The (003) plane orientation degree may be determined, for example, by subjecting a plate surface or a cross-section (processed with a cross section polisher, a focused ion beam, or the like) of the secondary grain to electron backscatter diffractometry (EBSD), transmission electron microscope (TEM), or the like to specify the orientation of the (003) plane in each primary grain in the secondary grain, and calculating a ratio of the number of primary grains whose orientations are aligned (within ±10°) with respect to the total number of primary grains.

The “aspect ratio” refers to a ratio of a size in a longitudinal direction (long axis size) to a size in a lateral direction (short axis size) of a grain. It can be said that, as a value for the ratio becomes closer to 1, the shape of the grain becomes closer to a spherical shape.

The “voidage” refers to a volume ratio of a void (pore: including an open pore and a closed pore) in the cathode active material of the present invention. The “voidage” is sometimes referred to as “porosity.” The “voidage” is determined, for example, by calculation from a bulk density and a true density.

The “average pore size” is an average of diameters of pores in the secondary grain. The “diameter” is typically, in the case of assuming a pore of interest to be a sphere having the same volume or the same cross-sectional area as the pore, a diameter of the sphere. It should be noted that the “average” is suitably one calculated on a number basis. Further, the average pore size may be determined, for example, by a well-known method such as image processing of an SEM photograph of a cross-section of the secondary grain or mercury porosimetry.

That is, the inventors of the present invention have made intensive studies. As a result, the inventors have found that cell characteristics can be additionally improved by:
substantially uniaxially orienting the (003) planes in the secondary grain of the cathode active material having a layered rock salt structure (providing, in the secondary grain, a large number of the primary grains which are monocrystalline for constituting the secondary grain so that the respective (003) planes are parallel with each other to the greatest possible extent: specifically, so that a (003) plane orientation degree of the primary grains in the secondary grain is 60% or more (preferably 75% or more)); and
adjusting an average grain size, an aspect ratio, a voidage, an average pore size, and a value obtained by dividing the average grain size of each of the primary grains by the average pore size in the secondary grain so as to fall within the above-mentioned predetermined ranges. Thus, the present invention has been completed.

In the cathode active material of the present invention having such configuration, a large number of the primary grains are present around the pores in the secondary grain, and a plurality of the primary grains adjacent to each other have electron conduction and lithium ion diffusion directions (in particular, an electron conduction direction) aligned satisfactorily. Thus, electron conduction and lithium ion diffusion pathways (in particular, an electron conduction pathway) in the secondary grain are satisfactorily secured. Therefore, according to the present invention, cell characteristics can be additionally improved than ever before.

It should be noted that, when the value “average primary grain size/average pore size” is 0.1 or more and 5 or less as described above, lithium ion conductivity and electron conductivity in the secondary grain are exhibited to the maximum extent.

In contrast, when the value “average primary grain size/average pore size” is less than 0.1, the number of the primary grains present around the pores becomes too large, and hence grain boundary resistance becomes too large, resulting in reductions in output characteristic and rate characteristic.

On the other hand, when the value “average primary grain size/average pore size” is more than 5, the number of contact points between the primary grains present around the pores becomes small, and hence electron conduction and lithium ion diffusion pathways (in particular, an electron conduction pathway) are hardly secured, resulting in a reduction in output characteristic. In particular, when the secondary grain has higher orientation property, the electron conduction and lithium ion diffusion pathways cross the (003) planes more frequently (such electron conduction or lithium ion diffusion crossing the (003) planes hardly occurs), resulting in a remarkable reduction in output characteristic.

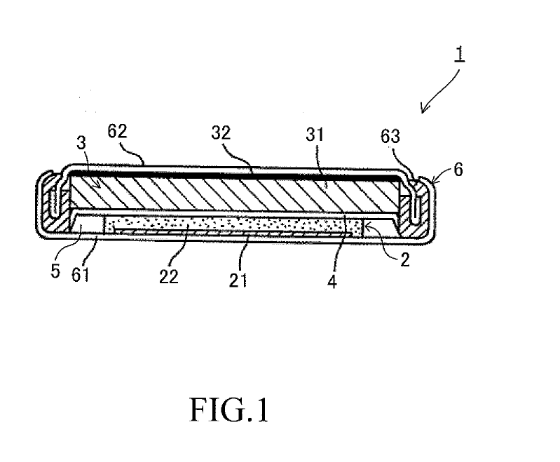

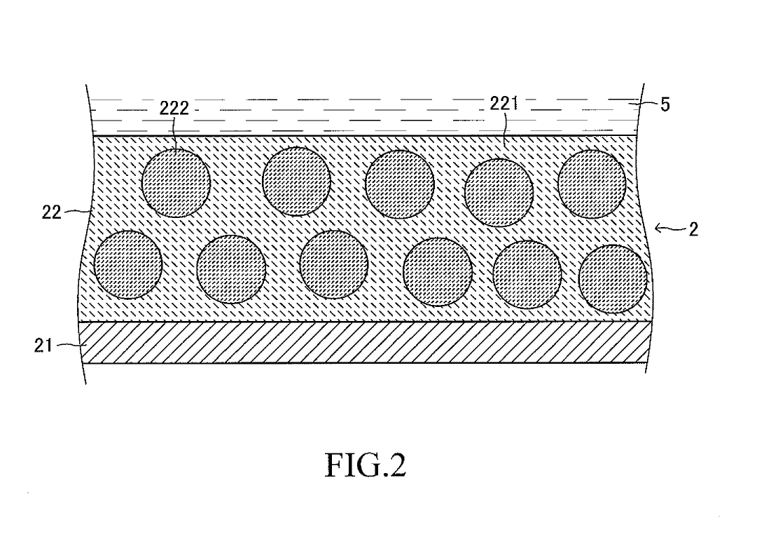

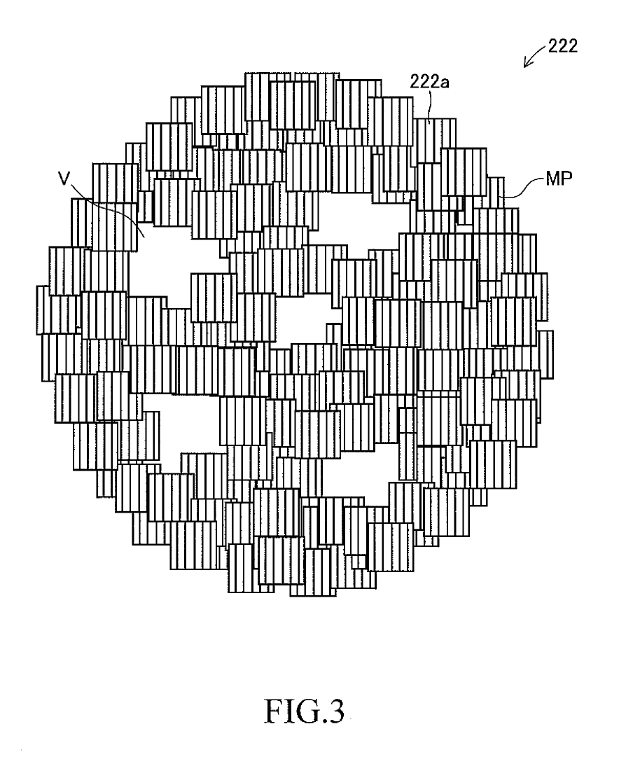

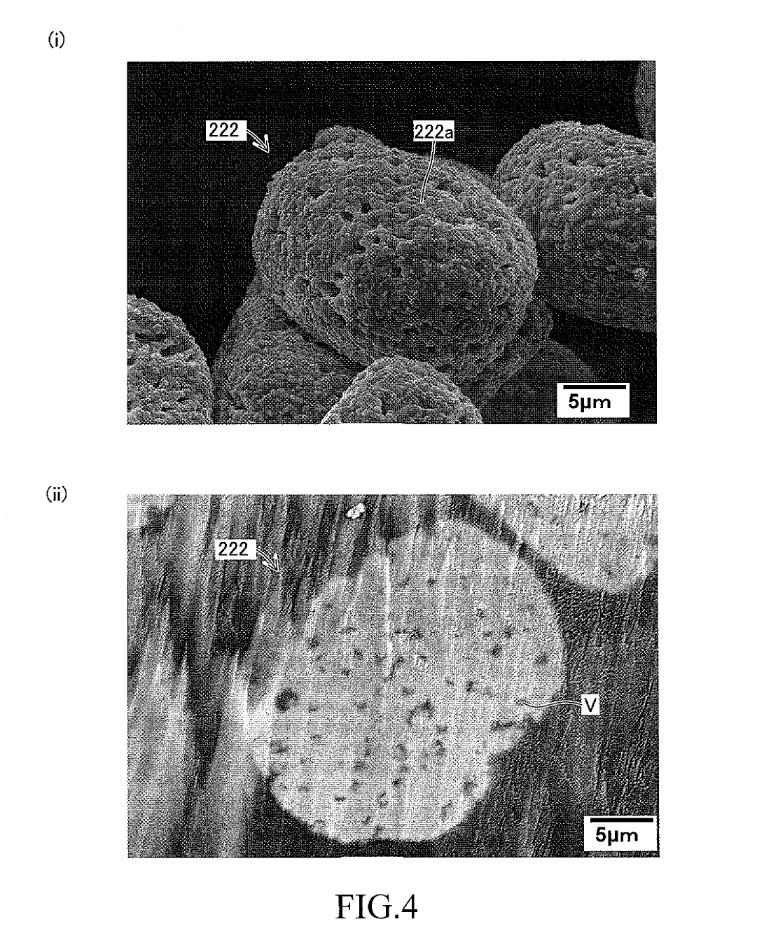

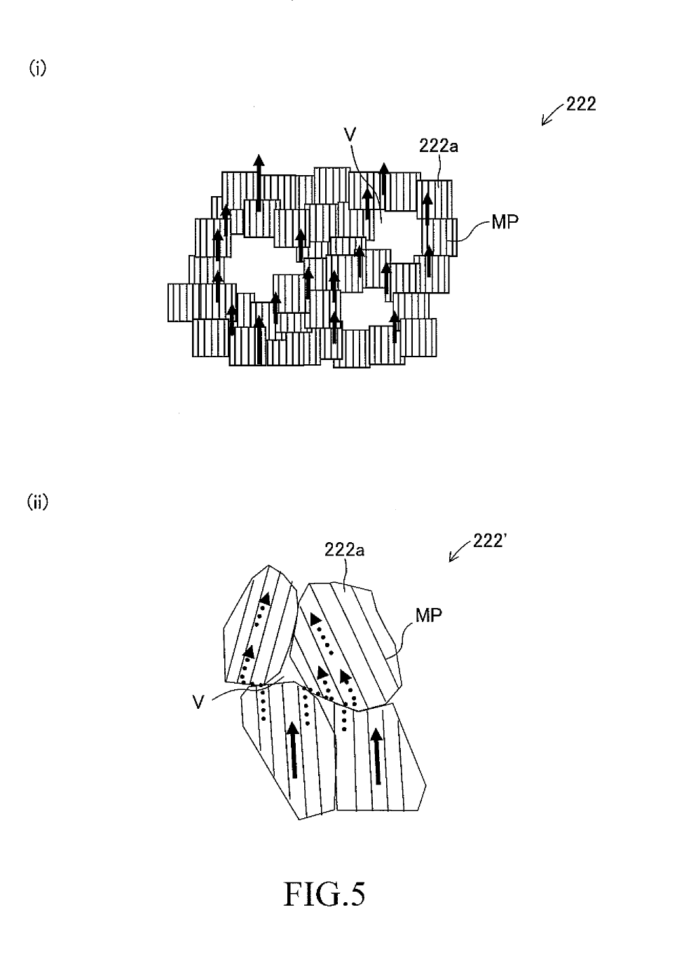

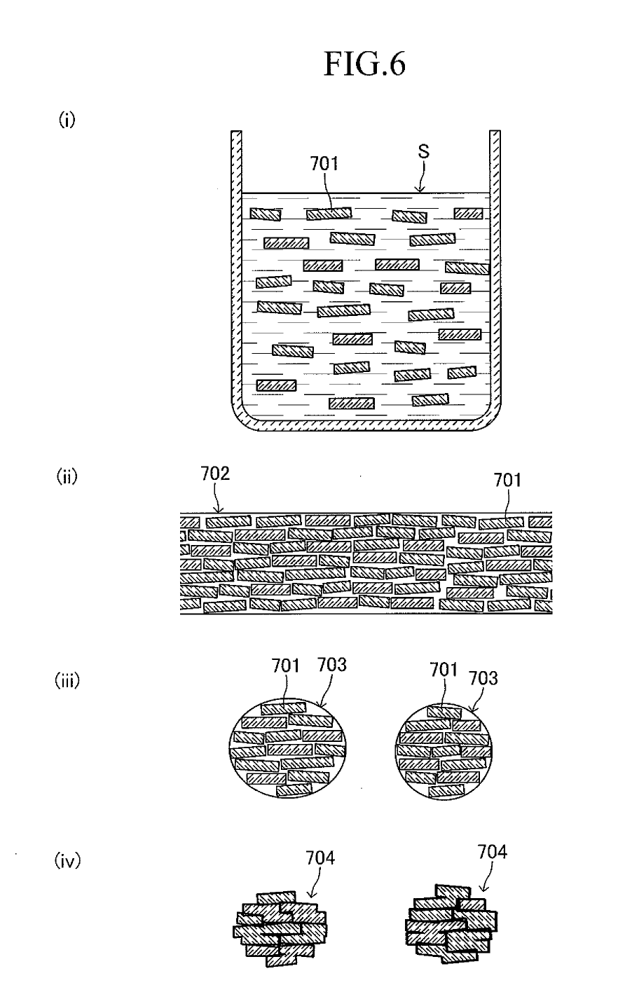

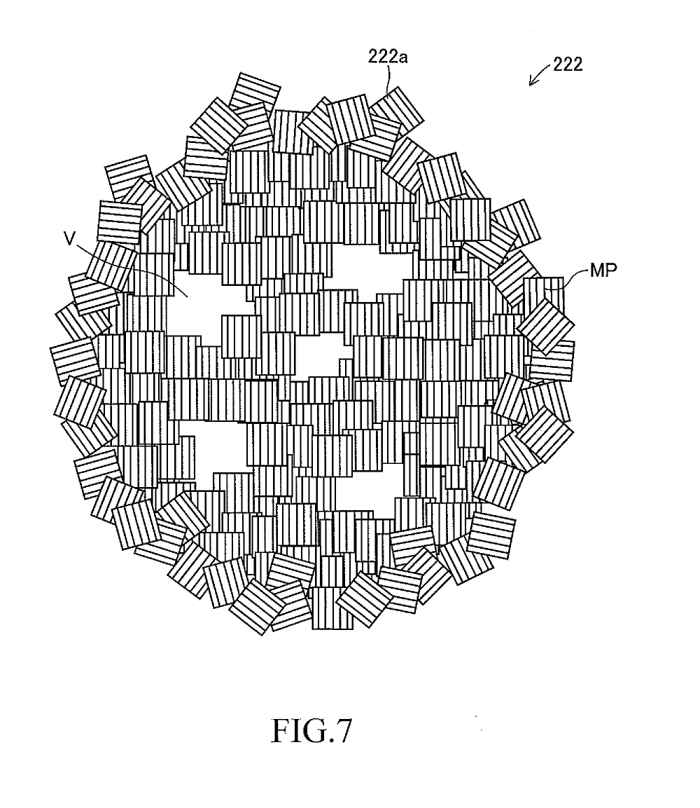

### BRIEF DESCRIPTION OF THE DRAWINGS

[FIG. 1] A cross-sectional view illustrating the schematic configuration of a lithium secondary battery to which an embodiment of the present invention is applied.

[FIG. 2] An enlarged cross-sectional view of a cathode plate illustrated in FIG. 1.

[FIG. 3] An enlarged view schematically illustrating a cathode active material particle according to this embodiment illustrated in FIG. 2.

[FIG. 4] Scanning electron microscope photographs of the cathode active material particle according to this embodiment illustrated in FIG. 3.

[FIG. 5] Partially enlarged views schematically illustrating a state of lithium ion diffusion in the cathode active material particle according to this embodiment illustrated in FIG. 3 and that in the case of a conventional cathode active material for comparison.

[FIG. 6] Views each schematically illustrating an exemplary production method for the cathode active material particle according to this embodiment illustrated in FIG. 2.

[FIG. 7] A view illustrating the configuration of an exemplary modification of the cathode active material particle illustrated in FIG. 3.

### MODES FOR CARRYING OUT THE INVENTION

Hereinafter, suitable embodiments of the present invention are described by way of examples and comparative examples. It should be noted that the following descriptions of embodiments are nothing more than specific descriptions of mere exemplary embodiments of the present invention made to the greatest possible extent in order to fulfill description requirements (e.g., a descriptive requirement and an enabling requirement) of a specification required by law.

Thus, as described later, it is quite natural that the present invention be by no means limited to the specific configurations of embodiments and examples to be described below. It should be noted that various exemplary modifications which may be made to these embodiments and examples are collectively described herein at the end to the greatest possible extent because the insertion thereof into descriptions of the embodiments disturbs the consistent understanding of the descriptions of the embodiments.

### 1. CONFIGURATION OF LITHIUM SECONDARY BATTERY

FIG. 1 is a cross-sectional view illustrating the schematic configuration of a lithium secondary battery 1 to which an embodiment of the present invention is applied. Hereinafter, referring to FIG. 1, the lithium secondary battery 1 is the so-called liquid type coin cell and includes a cathode plate 2, an anode plate 3, a separator 4, an electrolytic solution 5, and a cell casing 6.

The cathode plate 2 is formed by stacking a cathode collector 21 and a cathode active material layer 22. Similarly, the anode plate 3 is formed by stacking an anode active material layer 31 and an anode collector 32.

The lithium secondary battery 1 is formed by stacking the cathode collector 21, the cathode active material layer 22, the separator 4, the anode layer 31, and the anode collector 32 in this order and liquid-tightly sealing the stack and the electrolytic solution 5 containing a lithium compound as an electrolyte in the cell casing 6 (including a cathode side container 61, an anode side container 62, and an insulating gasket 63).

Portions other than the cathode active material layer 22 in the lithium secondary battery 1 may be formed using various conventionally well-known materials. For example, as an anode active material for constituting the anode layer 31, there may be used an amorphous carbonaceous material such as soft carbon or hard carbon, a highly graphitized carbon material such as synthetic graphite or natural graphite, acetylene black, or the like. Of those, it is preferred to use a highly graphitized carbon material having a large lithium capacity. An anode material prepared using each of those anode active materials is applied onto the anode collector 32 formed of a metal foil or the like to form the anode plate 3.

As an organic solvent to be used for the electrolytic solution 5 which is nonaqueous, there is suitably used a carbonic acid ester-based solvent such as ethylene carbonate (EC), diethyl carbonate (DEC), dimethyl carbonate (DMC), or propylene carbonate (PC), any other sole solvent such as γ-butyrolactone, tetrahydrofuran, or acetonitrile, or a mixed solvent thereof.

As the electrolyte contained in the electrolytic solution 5, there may be used: a lithium complex fluorine compound such as lithium hexafluorophosphate (LiPF₆) or lithium borofluoride (LiBF₄); a lithium halide such as lithium perchlorate (LiClO₄); or the like. It should be noted that the electrolytic solution 5 is generally prepared by dissolving one or more kinds of those electrolytes in the organic solvent described above. Of those, it is suitable to use LiPF₆ which hardly undergoes oxidative decomposition and imparts high conductivity to the nonaqueous electrolytic solution.

It should be noted that the portions other than the cathode active material layer 22 in the lithium secondary battery 1 are well-known, and hence further detailed descriptions of those portions are omitted herein.

### 2. CONFIGURATION OF CATHODE ACTIVE MATERIAL LAYER AND CATHODE ACTIVE MATERIAL PARTICLE

FIG. 2 is an enlarged cross-sectional view of the cathode plate 2 illustrated in FIG. 1. Referring to FIG. 2, the cathode active material layer 22 is formed of a binder 221, cathode active material particles 222 uniformly dispersed in the binder 221, and a conduction aid (e.g., carbon) and is joined to the cathode collector 21. That is, the cathode plate 2 is formed by mixing the cathode active material particles 222, polyvinylidene fluoride (PVDF) or the like as the binder 221, and acetylene black or the like as a conductive agent at a predetermined ratio to prerare a cathode material and applying such cathode material onto a surface of the cathode collector 21 formed of a metal foil or the like.

The cathode active material particle 222 according to this embodiment is a fine particle having an average particle size of 1 μm or more and 100 μm or less and is formed so as to have a substantially spherical shape or a substantially spheroid shape, specifically an aspect ratio of 1.0 or more and less than 2 (preferably 1.1 to 1.5).

FIG. 3 is an enlarged view schematically illustrating the cathode active material particle 222 (Example 1 to be described later) according to this embodiment illustrated in FIG. 2. Further, FIG. 4 shows SEM photographs of the cathode active material particle 222 according to this embodiment illustrated in FIG. 3. In FIG. 4, (i) is an SEM photograph of a surface of the particle and (ii) is an SEM photograph of a cross-section of the particle.

As illustrated in FIG. 3, the cathode active material particle 222 is a secondary grain including an assembly of a plurality of monocrystalline primary grains 222a of a lithium composite oxide having a layered rock salt structure. The monocrystalline primary grains 222a each have an average grain size of 0.01 μm or more and 5 μm or less and are formed so that the (003) planes indicated by “MP” in the figure are in-plane oriented (i.e., the (003) planes are oriented so as to intersect with plate surfaces of the monocrystalline primary grains 222a). It should be noted that, needless to say, all of the (003) planes are parallel with each other in one monocrystalline primary grain 222a.

The cathode active material particle 222 according to this embodiment has high uniaxial orientation property of the (003) planes. That is, in the cathode active material particle 222, a large number of the monocrystalline primary grains 222a for constituting the particle are provided so that orientations of the respective (003) planes are aligned with each other (so that the respective (003) planes are parallel with each other to the greatest possible extent). Specifically, the cathode active material particle 222 is formed so that a (003) plane orientation degree is 60% or more (preferably 75% or more) (so that a ratio of the monocrystalline primary grains 222a having the same (003) plane orientation property with respect to the total number of a plurality of the monocrystalline primary grains 222a contained in the cathode active material particle 222 is 60% or more (preferably 75% or more)).

Further, the cathode active material particle 222 has a large number of pores V. That is, the cathode active material particle 222 has a voidage of 3% or more and 30% or less and an average pore size of 0.1 μm or more and 5 μm or less. In addition, the cathode active material particle 222 has a value obtained by dividing the average grain size of each of the monocrystalline primary grains 222a by the average pore size of 0.1 or more and 5 or less.

### 3. ACTIONS AND EFFECTS BASED ON CONFIGURATION OF CATHODE ACTIVE MATERIAL PARTICLE ACCORDING TO EMBODIMENT

FIG. 5 shows partially enlarged views schematically illustrating a state of lithium ion diffusion in the cathode active material particle 222 according to this embodiment illustrated in FIG. 3 and that in the case of a conventional cathode active material for comparison. It should be noted that, in FIG. 5, (i) is a partially enlarged view of the cathode active material particle 222 according to this embodiment and (ii) is a partially enlarged view of a conventional cathode active material particle 222′. Further, the arrows in the figures each indicate a state of electron conduction.

The cathode active material particle 222 according to this embodiment contains the monocrystalline primary grains 222a so that the (003) planes are substantially uniaxially oriented (specifically, the (003) plane orientation degree is 60% or more (preferably 75% or more)), and has a voidage of 3% or more and 30% or less, an average pore size of 0.1 μm or more and 5 μm or less, and a value “average primary grain size/average pore size” of 0.1 or more and 5 or less.

In the cathode active material particle 222 according to this embodiment having such configuration, a large number of the monocrystalline primary grains 222a are present around the pores V (to such an extent that grain boundary resistance does not excessively increase), and a plurality of the monocrystalline primary grains 222a adjacent to each other have electron conduction and lithium ion diffusion directions aligned satisfactorily. Hence, electron conduction and lithium ion diffusion pathways are satisfactorily secured. Thus, electron conduction resistance and lithium ion diffusion resistance between the monocrystalline primary grains 222a are reduced to improve lithium ion conductivity and electron conductivity. Accordingly, the cathode active material particle 222 according to this embodiment can remarkably improve charge-discharge characteristics (in particular, a rate characteristic and an output characteristic) of the lithium secondary battery 1.

In contrast, in the conventional cathode active material particle 222′ (see, for example, Japanese Patent No. 4,740,409 and Japanese Patent No. 4,740,415) illustrated in (ii) of FIG. 5, the number of the monocrystalline primary grains 222a present around the pores V is small, and electron conduction and lithium ion diffusion pathways at the grain boundary become uncontinuous (see the broken-line arrows in the figure). Thus, with such configuration, the electron conduction and lithium ion diffusion pathways are not satisfactorily secured, with the result that satisfactory lithium ion conductivity and electron conductivity are not obtained.

Hereinafter, actions and effects based on the configuration of the cathode active material particle 222 according to this embodiment are described in more detail. As described above, in the cathode active material particle 222 according to this embodiment, the (003) planes are substantially uniaxially oriented, specifically, the (003) plane orientation degree is 60% or more (preferably 75% or more). As a result, lithium ion diffusion resistance and electron conduction resistance between the monocrystalline primary grains 222a adjacent to each other (i.e., at the grain boundary) are reduced to improve lithium ion diffusibility and electron conductivity. Thus, charge-discharge characteristics (in particular, a rate characteristic and an output characteristic) of the lithium secondary battery 1 can be remarkably improved.

That is, as illustrated in (i) of FIG. 5, the (003) planes (see “MP” in the figure) of the monocrystalline primary grains 222a for constituting the cathode active material particle 222 containing the pores V are oriented in a certain direction, leading to a reduction in grain boundary resistance. By virtue of such reduction in grain boundary resistance and the pores V each having an electrolytic solution and a conductive material therein, lithium ion diffusibility and electron conductivity in the cathode active material particle 222 containing the pores V are exhibited to the maximum extent.

In contrast, as illustrated in (ii) of FIG. 5, when the conventional cathode active material particle 222′ contains the pore V, lithium ion diffusion and electron conduction pathways become narrower, although an electrolytic solution permeates such pore V. Thus, reductions in lithium ion conductivity and electron conductivity occur. In this case, a site at which the lithium ion diffusion and electron conduction pathways become the narrowest (neck site) is often a grain boundary. Thus, remarkable reductions in lithium ion diffusibility and electron conductivity occur in the case of high grain boundary resistance.

In particular, electron conduction cannot occur via the pores V and needs to occur via the grain boundary between the monocrystalline primary grains 222a adjacent to each other. In this regard, according to the cathode active material particle 222 according to this embodiment, electron conductivity is satisfactorily secured. In contrast, in the conventional cathode active material particle 222′ (see, for example, Japanese Patent No. 4,740,409 and Japanese Patent No. 4,740,415) described above, satisfactory electron conductivity is hardly secured.

Further, there is an increased probability that a micro crack, which generally occurs between the monocrystalline primary grains 222a (i.e., at the grain boundary) through a volumetric expansion or contraction due to repeated charge-discharge, may occur in a direction parallel with the (003) plane which is a lithium ion diffusion plane and an electron conduction plane (i.e., in a direction that does not result in lithium ion diffusion resistance and does not affect electron conductivity). Thus, the deterioration of charge-discharge characteristics (in particular, a rate characteristic) due to repeated charge-discharge cycles can be suppressed.

It should be noted that the (003) plane orientation degree is preferably 70% or more, particularly preferably 90%. It can be said that, as the rate of orientation becomes higher, in-plane directions of the (003) planes, each of which is a direction in which lithium ion diffusion and electron conduction occur satisfactorily, are parallel with each other at a higher ratio in a large number of the monocrystalline primary grains 222a contained in the cathode active material particle 222. Thus, as the rate of orientation becomes higher, distances for lithium ion diffusion and electron conduction become shorter, and as described above, the lithium ion diffusion resistance and electron resistance are reduced, thereby more remarkably improving charge-discharge characteristics of the lithium secondary battery 1. Accordingly, for example, even in the case of using the cathode active material particle 222 as a cathode material for the liquid type lithium secondary battery 1 and increasing the average particle size of the cathode active material particle 222 for the purposes of an improvement in durability, an increase in capacity, and an improvement in safety, a high rate characteristic can be maintained by increasing the rate of orientation.

Further, the average grain size of each of the monocrystalline primary grains 222a is 0.01 μm or more and 5 μm or less, preferably 0.01 μm or more and 3 μm or less, more preferably 0.01 μm or more and 1.5 μm or less. The crystallinity of the monocrystalline primary grains 222a is secured by adjusting the average grain size of each of the monocrystalline primary grains 222a within this range.

In this regard, when the average grain size of each of the monocrystalline primary grains 222a is less than 0.1 μm, a reduction in crystallinity of the monocrystalline primary grains 222a may occur, resulting in reductions in output characteristic and rate characteristic of the lithium secondary battery 1. However, in the cathode active material particle 222 according to this embodiment, even when the average grain size of each of the monocrystalline primary grains 222a is 0.1 to 0.01 μm, no large reductions in output characteristic and rate characteristic are observed.

Further, the adjustment of the average grain size of each of the monocrystalline primary grains 222a within this range suppresses the occurrence of a crack to the greatest possible extent in the cathode active material particle 222 as the secondary grain even when each of the monocrystalline primary grains 222a undergoes a volumetric expansion or contraction during charge-discharge. In contrast, when the average grain size of each of the monocrystalline primary grains 222a is more than 5 μm, a crack may occur in the cathode active material particle 222 as the secondary grain owing to a stress due to a volumetric expansion or contraction of each of the monocrystalline primary grains 222a during charge-discharge.

The average particle size of the cathode active material particle 222 as the secondary grain is 1 μm or more and 100 μm or less, preferably 2 μm or more and 70 μm or less, more preferably 3 μm or more and 50 μm or less. The adjustment of the average particle size of the cathode active material particle 222 within this range secures the filling property of the cathode active material in the cathode active material particle 222 (improvement in filling ratio). Further, a flat electrode surface can be formed while the output characteristic and rate characteristic of the lithium secondary battery 1 are maintained.

In contrast, when the average particle size of the cathode active material particle 222 is less than 1 μm, a reduction in filling ratio of the cathode active material may occur. On the other hand, when the average particle size of the cathode active material particle 222 is more than 100 μm, a reduction in planarity of an electrode surface as well as reductions in output characteristic and rate characteristic of the lithium secondary battery 1 may occur.

The distribution of the average particle size of the cathode active material particle 222 may be sharp or broad, or may have a plurality of peaks. For example, when the distribution of the average particle size of the cathode active material particle 222 is not sharp, the filling density of the cathode active material in the cathode active material layer 22 may be increased, or an adhesive force between the cathode active material layer 22 and the cathode collector 21 may be increased. Thus, charge-discharge characteristics can be additionally improved.

The aspect ratio of the cathode active material particle 222 is 1.0 or more and less than 2.0, preferably 1.1 or more and less than 1.5. Through the adjustment of the aspect ratio of the cathode active material particle 222 within this range, even in the case of increasing the filling density of the cathode active material in the cathode active material layer 22, such an appropriate gap as to allow securing of a pathway through which lithium ions in the electrolytic solution 5 impregnated into the cathode active material layer 22 diffuse in a thickness direction of the cathode active material layer 22 can be formed between the cathode active material particles 222. Thus, the output characteristic and rate characteristic of the lithium secondary battery 1 can be additionally improved.

On the other hand, when the aspect ratio of the cathode active material particle 222 is 2.0 or more, the cathode active material particle 222 is easily filled in a state in which a plate surface direction of the cathode collector 21 and a long axis direction of the particle are arrayed in parallel with each other during the formation of the cathode active material layer 22. As a result, a diffusion pathway of lithium ions in the electrolytic solution 5 impregnated into the cathode active material layer 22, in a thickness direction of the cathode active material layer 22 is lengthened. Thus, reductions in output characteristic and rate characteristic of the lithium secondary battery 1 may occur.

Further, the aspect ratio of each of the monocrystalline primary grains 222a is also preferably 1.0 or more and less than 2.0, more preferably 1.1 or more and less than 1.5. The adjustment of the aspect ratio of each of the monocrystalline primary grains 222a within this range satisfactorily secures lithium ion conductivity and electron conductivity.

The voidage (volume ratio of the pores V) in the cathode active material particle 222 is 3% or more and 30% or less. The adjustment of the voidage within this range can provide an effect of improving charge-discharge characteristics without impairing a capacity.

The average pore size (average of diameters of the pores V in the cathode active material particle 222) in the cathode active material particle 222 is 0.1 μm or more and 5 μm or less. When the average pore size is more than 5 μm, relatively large pores V are generated. When such large pores V are present, the amount per volume of the cathode active material contributing to charge-discharge reduces. Further, stress concentration is more liable to occur in a local area of each of such large pores V, and an effect of uniformly releasing a stress in the inside is hardly obtained. On the other hand, when the average pore size is less than 0.1 μm, it becomes difficult to incorporate a conductive material and an electrolyte in the pores, and a stress releasing effect of the pores V is not sufficiently obtained. Thus, an effect of improving charge-discharge characteristics while maintaining a high capacity may not be expected.

It should be noted that, in order to realize the desired voidage and average pore size as described above, a pore-forming material (void-forming material) as an additive has only to be blended into raw materials. As such pore-forming material, there may be suitably used a particulate or fibrous substance to be decomposed (evaporated or carbonized) in a calcination step. Specifically, there may be suitably used a particulate or fibrous substance of theobromine, nylon, graphite, a phenolic resin, polymethyl methacrylate, polyethylene, polyethylene terephthalate, or an organic synthetic resin such as a foamable resin. As a matter of course, even when such pore-forming material is not used, it is possible to realize the desired voidage and average pore size as described above by appropriately adjusting, for example, the kind and particle size of a raw material particle and a firing temperature in a calcination (thermal treatment) step.

### 4. OVERVIEW OF PRODUCTION METHOD

The cathode active material particles 222 may be produced, for example, by a production method to be described below. FIG. 6 shows a view schematically illustrating an example of such production method.

### (1) Preparation of Raw Material Particles

As raw material particles, there may be used a product obtained by appropriately mixing particles of compounds of Li, Co, Ni, Mn, Al, and the like so that the composition of a cathode active material is LiMO₂. Specifically, there may be used, for example, mixed particles of the respective compounds of Co, Ni, Mn, Al, and the like free of a lithium compound (mixed particles each having a composition such as (Co, Ni, Mn)Oₓ, (Co, Ni, Al)Oₓ, (Co, Ni, Mn)OHₓ, or (Co, Ni, Al)OHₓ). The cathode active material particles 222 each having a predetermined composition can be obtained by forming the mixed particles and further subjecting the resultant compact to a reaction with a lithium compound.

For the purpose of increasing the rate of orientation described above, it is preferred to use hydroxides each having a composition such as (Co, Ni, Mn)OHₓ or (Co, Ni, Al)OHₓ as the raw material particles. Each of such hydroxides has a flat primary grain shape having a (001) plane in a flat plane, and hence it is easy to orient the primary grain by a forming step to be described later. Such (001) plane is a plane whose orientation is transferred as a (003) plane in a cathode active material having a predetermined composition through a reaction with a lithium compound. Thus, the use of such plate-like raw material particles allows the (003) planes in the cathode active material particles 222 to be easily oriented.

It should be noted that, in consideration of the promotion of particle growth or evaporation of lithium during firing, the lithium compound may be loaded in a larger amount in the raw material particles so that lithium is present in an excess of 0.5 to 40 mol %. Further, a low melting point oxide (e.g., bismuth oxide), a low melting point glass (e.g., borosilicate glass), lithium fluoride, lithium chloride, or the like may be added to the raw material particles at 0.001 to 30 mass % for the purpose of promoting particle growth. In addition, in order to realize the desired “voidage” and “average pore size” as described above, the pore-forming material (void-forming material) may be appropriately added as described above.

Further, the raw material particles may be partially replaced by other raw materials. For example, Mn in (Co, Ni, Mn)OHₓ may be partially replaced by MnCO₃. This realizes sufficient orientation property and allows the pore size and the voidage to be changed.

### (2) Forming of Raw Material Particles

The prepared raw material particles are formed into a sheet-like self-supported compact having a thickness of 100 μm or less. As used herein, the “self-supported compact” refers to one capable of keeping the shape of a sheet-like compact in itself, in principle. In this regard, however, the “self-supported compact” encompasses a compact which is formed into a sheet shape once by being attached to an appropriate substrate or formed into a film and is then peeled from the substrate before firing or after firing even if the compact cannot keep the shape of a sheet-like compact in itself during a certain period of time. Specifically, a sheet obtained by extrusion molding serves as a “self-supported compact” from immediately after the forming. In contrast, a coated film of a slurry cannot be handled in itself before drying, but serves as a “self-supported compact” after having been dried and then peeled from a substrate. Further, the concept of “sheet-like” encompasses plate-like, flake-like, scale-like, and the like.

A forming method is not particularly limited as long as raw material particles are filled with their crystal orientations being aligned with each other in a compact. For example, a slurry containing raw material particles may be formed into a film (formed) by a doctor blade method to provide a (self-supported sheet-like) compact with the raw material particles filled in an aligned crystal orientation. Specifically, in the case of employing the doctor blade method, first, a slurry S containing raw material particles 701 (see (i) of FIG. 6) is applied onto a substrate having flexibility (e.g., an organic polymer plate such as a PET film). The applied slurry S is dried and solidified to provide a dried film. Next, the dried film is peeled from the substrate described above to give a compact 702 in which the raw material particles 701 are oriented (filled with their crystal orientations being aligned with each other) (see (ii) of FIG. 6).

Alternatively, through the use of a drum dryer, a slurry containing raw material particles may be applied onto a heated drum, dried, and scraped from the drum with a scraper to produce the compact 702. Alternatively, through the use of a disk dryer, a slurry containing raw material particles may be applied onto a heated circular plate surface, dried, and scraped with a scraper to produce the compact 702. Alternatively, clay containing raw material particles may be subjected to extrusion molding to produce the compact 702.

In the stage of preparing a slurry or clay before forming, a binder, a plasticizer, or the like may be appropriately added to the raw material particles dispersed in an appropriate dispersion medium. The kind and amount of an additive such as a binder are appropriately adjusted so that the filling density and degree of orientation of raw material particles during forming or the shape of a crushed product in a crushing step to be described later can be controlled to a desired state. Specifically, for example, when a compact before crushing has high flexibility, a crushed product tends to have a larger aspect ratio during crushing. Thus, the kind and addition amount of a binder, a plasticizer, or the like may be appropriately adjusted so as to prevent the flexibility of the compact before crushing from becoming too high. Thus, for example, in order to control the flexibility of the compact before crushing, the compact may be dried at about 200 to 500° C. at which the denaturation and decomposition of the binder occur.

In the case of using the slurry containing raw material particles, it is preferred to adjust the viscosity to 0.5 to 5 Pa·s and to remove bubbles under reduced pressure. In addition, in the case of allowing any other compound to be present in the cavities V, it is preferred to prepare a slurry containing the compound and the raw material particles.

The thickness of the compact 702 is preferably 120 μm or less, more preferably 100 μm or less. Further, the thickness of the compact 702 is preferably 1 μm or more. When the thickness of the compact 702 is 1 μm or more, a self-supported sheet-like compact is easily produced. It should be noted that the thickness of the compact 702 serves as a direct factor that determines the average particle size of each of the cathode active material particles 222, and hence is appropriately set depending on applications of the particles.

### (3) Crushing of Compact

The resultant compact 702 is crushed so that each of the cathode active material particles 222 has a desired aspect ratio. For the crushing, there may be used, for example, the following: a method involving pressing the compact against a mesh with a spatula or the like; a method involving crushing the compact with a crusher having a weak crushing power, such as a pin mill; a method involving allowing sheet pieces of the compact to collide with each other in an air flow (specifically, a method involving loading the compact into an air-flow classifier); a swirling type jet mill; pot crushing; barrel polishing; or the like.

Further, the crushed product may be machined so as to have a spherical shape may be carried out. Through the treatment, each of the cathode active material particles 222 to be finally produced has a substantially spherical shape or a substantially spheroidal shape. When each of the cathode active material particles 222 has a substantially spherical shape or a substantially spheroidal shape, the exposure of lithium ion intercalation and deintercalation planes and electron conduction planes in the outer surfaces of the particles is increased, and the filling rate of the cathode active material in the cathode active material layer 22 is improved, thus improving cell characteristics.

For the spherical machining, for example, the following method may be employed: a method involving allowing particles as a crushed product to collide with each other in an air flow to round off the “corners” of the particles as the crushed product (e.g., air-flow classification or hybridization); a method involving allowing particles as a crushed product to collide with each other in a container to round off the “corners” of the particles as the crushed product (e.g., a method involving using a hybrid mixer and a high-speed stirrer or mixer, or barrel polishing); a mechanochemical method; or a method involving melting surfaces of particles as a crushed product with hot air. The spherical machining and the crushing may be carried out separately, or may also be carried out simultaneously. That is, for example, the crushing and the spherical machining may be simultaneously carried out through the use of an air-flow classifier.

It should be noted that, in order to facilitate the crushing and the spherical machining, the compact may be subjected to degreasing or thermal treatment (firing or calcination) in advance. For example, as described above, in order to control the flexibility of a compact before crushing, the compact may be dried at such a relatively high temperature as to cause denaturation and decomposition of a binder. Alternatively, when the raw material particles are plate-like (e.g., when the raw material particles are hydroxides), the compact before crushing has such an internal structure that a large number of plate-like raw material particles aggregate while being arrayed in parallel with a plate surface of the compact. Thus, such compact is liable to have anisotropy in strength, and thus a crushed product obtained during crushing tends to have a large aspect ratio (i.e., it becomes difficult to adjust the aspect ratio to less than 2). Thus, in this case, it is preferred to carry out calcination before crushing or carry out crushing after a firing step (lithium incorporation step) to be described later.

The calcination before crushing allows an internal structure of the compact before crushing and before firing (before lithium incorporation) to be controlled to a state in which an oxide having an isotropic shape is necked, which makes it easy to adjust the aspect ratio of a crushed product during crushing to less than 2. A calcination temperature preferably falls within the range of 400 to 1,100° C. When the calcination temperature is less than 400° C., the necking described above insufficiently proceeds, which makes a compact after calcination brittle, with the result that the particle size of the crushed product becomes excessively finer by the crushing. On the other hand, when the calcination temperature is more than 1,100° C., the sintering of raw materials excessively proceeds and a reaction during the subsequent lithium incorporation hardly proceeds, with the result that a lithium composite oxide having a desired composition is not synthesized. It is particularly suitable that such calcination before crushing be carried out in such a composition that an adverse influence such as phase separation is hardly caused by the calcination (e.g., a system containing nickel and not containing manganese, such as a nickel-cobalt system, a nickel-cobalt-aluminum system, or a nickel-aluminum system).

When the calcination is carried, pores may be controlled by changing a rate of temperature increase. The rate of temperature increase preferably falls within the range of 10 to 400° C./h. When the rate of temperature increase is less than 10° C./h, the array of raw material particles may be disturbed during the formation of the pores, resulting in a reduction in rate of orientation. On the other hand, when the rate of temperature increase is more than 400° C./h, an effect of a pore-forming material cannot be sufficiently exhibited, which makes it difficult to provide a pore size and a voidage of interest.

When the calcination is not carried out before the crushing, a state in which raw material particles (plate-like raw material particles) 701 are oriented satisfactorily still remains in each of cathode active material precursor material particles 703 as the resultant crushed product (see (iii) of FIG. 6). That is, each of the cathode active material precursor material particles 703 is a raw material particle assembly containing a large number of the plate-like raw material particles 701 and is formed so that those raw material particles 701 are substantially uniformly oriented.

On the other hand, when the calcination is carried out before the crushing, the necking (particle growth) described above proceeds. Hence, a state in which raw material particles (plate-like raw material particles) 701 are oriented does not remain in each of cathode active material precursor material particles 704 as the resultant crushed product (see (iv) of FIG. 6). That is, each of the cathode active material precursor material particles 704 has such an internal structure as to correspond to a thermally treated product of each of the cathode active material precursor material particles 703. Thus, the cathode active material precursor material particles 704 may also be formed by first producing the cathode active material precursor material particles 703 by crushing without carrying out calcination, and then subjecting the resultant to calcination.

Among the products obtained during the crushing or the spherical machining, the products other than those each having a desired aspect ratio (e.g., products each still having a large aspect ratio as a result of insufficient crushing) and fine powders may be reutilized as raw materials.

As described above, the cathode active material precursor material particles 703 or 704 each having an aspect ratio of 1.0 or more and less than 2.0 (preferably 1.1 to 1.5) and having a predetermined internal structure are formed so that each of the cathode active material particles 222 has a desired aspect ratio and a desired state of (003) plane orientation.

(4) Mixing with Lithium Compound

The cathode active material precursor material particles 703 or 704 obtained as described above are mixed with a lithium compound (e.g., lithium hydroxide or lithium carbonate) to produce a mixture before firing. As a mixing method, dry mixing, wet mixing, or the like is employed. The lithium compound preferably has an average particle size of 0.1 to 5 μm. When the lithium compound has an average particle size of 0.1 μm or more, the lithium compound is easily handled from the viewpoint of hygroscopicity. Further, when the lithium compound has an average particle size of 5 μm or less, reactivity with a crushed product is enhanced. It should be noted that the amount of lithium may be set in an excess of 0.5 to 40 mol % in order to enhance the reactivity.

### (5) Firing (Lithium Incorporation)

The mixture before firing described above is fired by an appropriate method to incorporate lithium into the cathode active material precursor material particles 703 or 704, thereby producing the cathode active material particles 222. Specifically, the firing may be carried out, for example, by placing a sheath containing the mixture before firing described above in a furnace. Through the firing, the synthesis of a cathode active material, the sintering of particles, and particle growth are carried out. In this case, as described above, the (001) planes of the raw material particles are oriented in the compact (cathode active material precursor material particles 703 or 704). Hence, through the transfer of the crystal orientation, the cathode active material particles 222 each having a predetermined composition, in which the (003) planes are uniaxially oriented satisfactorily, can be obtained.

The firing temperature is preferably 600° C. to 1,100° C. When the firing temperature is a temperature of less than 600° C., particle growth may become insufficient, resulting in a reduction in rate of orientation. On the other hand, when the firing temperature is a temperature of more than 1,100° C., the decomposition of the cathode active material and the evaporation of lithium proceed, with the result that a predetermined composition may not be realized. The firing time is preferably set to 1 to 50 hours. When the firing time is less than 1 hour, a reduction in rate of orientation may occur. On the other hand, when the firing time is more than 50 hours, energy to be consumed for firing may become too large.

Further, for the purpose of enhancing the reactivity between lithium and a precursor material mixed in a temperature increasing process, temperature retention may be carried out at a lower temperature (e.g., 400 to 600° C.) than the firing temperature for 1 to 20 hours. Lithium is melted via such temperature retention step, which can enhance the reactivity. It should be noted that the adjustment of a rate of temperature increase in a certain temperature range (e.g., 400 to 600° C.) in the firing (lithium incorporation) step also provides a similar effect.

A firing atmosphere needs to be appropriately set so that decomposition does not proceed during the firing. When the evaporation of lithium proceeds, it is preferred to dispose lithium carbonate or the like in the same sheath to establish a lithium atmosphere. When oxygen is released and reduction proceeds during the firing, the firing is preferably carried out in an atmosphere at a high partial pressure of oxygen. It should be noted that, after the firing, crushing or classification (sometimes referred to as “secondary crushing” or “secondary classification” because the crushing or classification is carried out after the crushing or classification before firing described above) may be carried out, as appropriate, for the purposes of weakening adhesion and aggregation between the cathode active material particles 222 and adjusting the average particle size of each of the cathode active material particles 222. Alternatively, the crushing step described above may be carried out after the firing. That is, the crushing step (and the classification step) may be carried out only after the firing.

Further, in the cathode active material after the firing or via the crushing or classification step, post-thermal treatment may be carried out at 100 to 400° C. Such post-thermal treatment step can be carried out to modify surface layers of primary grains, thereby improving a rate characteristic and an output characteristic.

### 5. EXAMPLES

Hereinafter, examples (specific production examples) of the cathode active material particles 222 according to this embodiment and evaluation results thereof are described together with comparative examples. It should be noted that, in the following descriptions of examples and comparative examples, “part(s)” and “%” are on a mass basis unless otherwise stated. Further, for the purpose of the simplification of the description, the cathode active material particle 222 is simply referred to as “secondary grain” and an average particle size thereof is referred to as “secondary grain size.” Further, the monocrystalline primary grain 222a is simply referred to as “primary grain” and an average particle size thereof is referred to as “primary grain size.”

Further, measurement methods for various physical property values and evaluation methods for various characteristics are as described below.

### (Secondary Grain Size (μm))

A median size (D50) of secondary grains was measured with a laser diffraction/scattering type grain size distribution measuring apparatus (product of NIKKISO CO., LTD., model number “MT3000-II”) using water as a dispersion medium, and this value was defined as a secondary grain size.

### (Primary Grain Size (μm))

An SEM image was captured by selecting such a magnification that a visual field included 10 or more primary grains using a field emission type scanning electron microscope (FE-SEM: product of JEOL Ltd., product name “JSM-7000F”). In the SEM image, a circumscribed circle was drawn for each of 10 primary grains to determine a diameter of the circumscribed circle. Then, an average of the resultant diameters of the 10 primary grains was defined as a primary grain size.

### (Aspect Ratio of Secondary Grain)

Through the use of the FE-SEM described above, an SEM image was captured by selecting such a magnification that a visual field included 10 or more secondary grains. In the SEM image, each of 10 secondary grains was determined for its long axis size and short axis size. After that, a value obtained by dividing the long axis size by the short axis size was determined. Then, an average of the resultant 10 values was defined as an aspect ratio of the secondary grain.

### (Aspect Ratio of Primary Grain)

Through the use of the FE-SEM, an SEM image was captured by selecting such a magnification that a visual field included 10 or more primary grains. In the SEM image, each of 10 primary grains was determined for its long axis size and short axis size. After that, a value obtained by dividing the long axis size by the short axis size was determined. Then, an average of the resultant 10 values was defined as an aspect ratio of the primary grain.

### (Voidage (%))

The voidage was determined by calculation from a bulk density and a true density. Specifically, a relative density was calculated by dividing a bulk density determined by the Archimedes method by a true density determined with a pycnometer. Next, the relative density thus determined was substituted into the following general equation to calculate the voidage.

Voidage (%)=(1−relative density)×100 General equation

It should be noted that, in order to sufficiently purge air present in pores during the measurement of the bulk density, boiling treatment was carried out after a sample had been loaded into water. Further, in the case of a sample having a small pore size, boiling treatment was carried out after water had been impregnated into the pores with a vacuum impregnation apparatus (product of Struers A/S, apparatus name “CitoVac”) in advance.

### (Average Pore Size (μm))

The average pore size was measured by a mercury penetration method with a mercury penetration type porosimeter (product of Shimadzu Corporation, apparatus name “Autopore IV9510”).

### (Rate of Orientation (%))

A secondary grain powder was disposed on a glass substrate so as to prevent overlap of the secondary grains to the greatest possible extent. After that, the powder was transferred onto a pressure-sensitive tape, and the tape was impregnated with a synthetic resin. The synthetic resin-impregnated tape was polished so as to observe the polished plate surfaces or cross-sectional surfaces of the secondary grains, to thereby produce a sample for observation. It should be noted that, in the case of observation of the plate surfaces, polishing was carried out as final polishing by means of a vibration type rotary polisher using colloidal silica (0.05 μm) as an abrasive. On the other hand, in the case of observation of the cross-sectional surfaces, polishing was carried out by means of a cross section polisher.

The sample thus produced was subjected to crystal orientation analysis of each secondary grain in a visual field in which 10 or more primary grains were observed in one secondary grain by employing electron backscatter diffractometry (EBSD: measurement software “OIM Data Collection” and analysis software “OIM Analysis,” products of TSL Solutions K.K.) and setting a pixel resolution of measurement to 0.1 μm. Thus, the (003) plane of each primary grain was determined for its tilt angle with respect to a measured plane (polished plane).

A histogram (angle distribution) of the number of grains with respect to an angle was output, and an angle at which the number of primary grains reached the maximum (peak value) was defined as a (003) plane tilt angle θ with respect to the measured plane of the secondary grain. With respect to the tilt angle θ, the number of primary grains whose (003) planes were present within θ±10° in the measured secondary grain was calculated. The number of primary grains determined was divided by the total number of primary grains to calculate a (003) plane orientation degree in the measured secondary grain. This procedure was carried out in 10 different secondary grains, and an average of the resultant values was defined as a (003) plane orientation degree.

### (Percent Rate Capacity Maintenance (%))

In order to evaluate cell characteristics, a coin cell type battery was produced as described below.

The resultant secondary grain powder, acetylene black, and polyvinylidene fluoride (PVDF) were mixed at a mass ratio of 90:5:5, and dispersed in N-methyl-2-pyrrolidone to produce a cathode active material paste. This paste was applied onto an aluminum foil having a thickness of 20 μm as a cathode collector so as to have a uniform thickness (thickness after drying: 50 μm) and dried. The resultant sheet was punched into a disk shape having a diameter of 14 mm and pressed at a pressure of 2,000 kg/cm² to produce a cathode plate. The cathode plate thus produced was used to produce a coin cell as illustrated in FIG. 1.

It should be noted that an electrolytic solution was prepared by dissolving LiPF₆ in an equivolume mixture of ethylene carbonate (EC) and diethyl carbonate (DEC) serving as an organic solvent at a concentration of 1 mol/L.

Charge-discharge operations were carried out as described below using a battery (coin cell) for characteristic evaluation produced as described above to evaluate a percent rate capacity maintenance.

First, constant-current charge was carried out at 0.1 C rate of current until the cell voltage became 4.3 V. After that, constant-voltage charge was carried out under a current condition of maintaining the cell voltage at 4.3 V, until the current drops to 1/20, followed by a 10-minute rest. Then, constant-current discharge was carried out at 0.1 C rate of current until the cell voltage became 2.5 V, followed by a 10-minute rest. One cycle included those charge-discharge operations. A total of two cycles were repeated under a condition of 25° C., and a discharge capacity measured in the second cycle was defined as “discharge capacity at 0.1 C rate.”

Subsequently, current during charge was fixed to 0.1 C rate, current during discharge was fixed to 5 C rate, and two cycles of charge-discharge were repeated in the same manner as described above. Then, a discharge capacity measured in the second cycle was defined as “discharge capacity at 5 C rate.”

A value obtained by dividing the “discharge capacity at 5 C rate” by the “discharge capacity at 0.1 C rate” (in practice, a value expressed in terms of a percentage) was defined as a “percent rate capacity maintenance.”

### (Output Characteristic)

Constant-current charge was carried out at 0.1 C rate of current until the cell voltage became 4.3 V. After that, constant-voltage charge was carried out under a current condition of maintaining the cell voltage at 4.3 V, until the current drops to 1/20, followed by a 10-minute rest. Then, constant-current discharge was carried out at 5 C rate of current until the cell voltage became 2.5 V, followed by a 10-minute rest. One cycle included those charge-discharge operations. A total of two cycles were repeated under a condition of 25° C. A discharge voltage at the time of 90% in the case where a discharge capacity in the second cycle was defined as 100% (SOC 10% voltage: SOC is an abbreviation of “state of charge” and means a charged state) was read out from a discharge curve. This numerical value was used as an indicator of an output characteristic. As the numerical value becomes higher, the output characteristic becomes higher, which is preferred.

### 5-1: Nickel System Composition

### Example 1

### (1) Preparation of Raw Material Particles and Slurry

First, Ni(OH)₂ powder (product of Kojundo Chemical Laboratory Co., Ltd.), Co(OH)₂ powder (product of Kojundo Chemical Laboratory Co., Ltd.), and Al₂O₃.H₂O (product of SASOL) were weighed so that the molar ratio of Ni, Co, and Al in the resultant mixture was 80:15:5. Next, to such weighed product was added a pore-forming material (spherical: product of AIR WATER INC., trade name “Bellpearl R100”). The pore-forming material was weighed at a ratio of 2% with respect to the total weight of the powder after its addition. Then, the mixed powder after the addition of the pore-forming material was pulverized and mixed using a ball mill for 24 hours to prepare a raw material particle powder.

100 parts of the prepared raw material particle powder, 400 parts of pure water as a dispersion medium, 1 part of a binder (polyvinyl alcohol: product number VP-18, product of JAPAN VAM & POVAL CO., LTD.), 1 part of a dispersant (product name “MALIALIM KM-0521,” product of NOF CORPORATION), and 0.5 part of an antifoaming agent (1-octanol: product of Wako Pure Chemical Industries, Ltd.) were mixed. Then, the mixture was stirred under reduced pressure to remove bubbles, and the viscosity was adjusted to 0.5 Pa·s (measured with an LVT type viscometer, a product of Brookfield), to thereby prepare a slurry.

### (2) Forming and Thermal Treatment (Calcination) of Raw Material Particles

The slurry prepared as described above was formed into a sheet-like compact on a PET film by a doctor blade method so that the thickness of the compact after drying was 25 μm. The sheet-like compact peeled from the PET film after drying was placed at the center of a zirconia-made setter, and the temperature was increased at 200° C./h in air. Then, the sheet-like compact was thermally treated at 900° C. for 3 hours to produce a sheet-like (Ni_{0.8}Co_{0.15}Al_{0.05})O ceramics sheet.

### (3) Crushing of Compact

The ceramics sheet obtained by the thermal treatment (calcination) was placed on a sieve (mesh) having an opening diameter of 30 μm, and then a spatula was lightly pressed against the ceramics sheet so as to cause the ceramics sheet to pass through the mesh for crushing, to thereby produce (Ni_{0.8}Co_{0.15}Al_{0.05})O powder having a substantially spherical shape.

### (4) Spherical Machining and Classification of Crushed Product

The (Ni_{0.8}CO_{0.15}Al_{0.05})O powder obtained by the crushing was loaded into an air-flow classifier (product of Nisshin Engineering Inc., product name “TURBO CLASSIFIER,” model: TC-15: air-exhaust amount: 1.7 m³/min, classification rotor rotation number: 10,000 rpm) at a rate of 20 g/min, and coarser grains in the resultant powder were collected. Such spherical machining (classification with fine powder removal was also carried out simultaneously) was repeated five times.

(5) Mixing with Lithium Compound

The (Ni_{0.8}Co_{0.15}Al_{0.05})O powder after the fine powder removal was mixed with LiOH.H₂O powder (product of Wako Pure Chemical Industries, Ltd.) so as to achieve a molar ratio of Li/(Ni_{0.8}Co_{0.15}Al_{0.05})=1.05.

### (6) Firing Step (Lithium Incorporation Step)

The mixed powder described above was loaded into a crucible made of high-purity alumina and thermally treated in an oxygen atmosphere (0.1 MPa) at 775° C. for 24 hours to produce Li(Ni_{0.8}Co_{0.15}Al_{0.05})O₂ powder (Example 1).

### Examples 2 to 10 and Comparative Examples 1 to 3

Powders of Examples 2 to 10 and Comparative Examples 1 to 3 were obtained by modifying the kind and addition amount of the pore-forming material, the forming method, the presence or absence of the calcination and conditions therefor, the mesh opening diameter during the crushing, and the presence or absence of the spherical machining in the production method of Example 1 described above (see Table 1).

It should be noted that the same pore-forming material as in Example 1 described above is used in the case where the “pore-forming material” is “spherical” in Table 1. On the other hand, “CELISH PC110S” (trade name, product of Daicel FineChem Ltd.) is used as the pore-forming material in the case where the “pore-forming material” is “fibrous.”

Further, powder forming in Comparative Example 2, in which spray drying was employed in place of the tape forming, was carried out as follows: a spray dryer (product of Sakamoto Giken. Co.: turning type, model: TSR-3W) was used to produce a spherical granule under the conditions of a flow rate of 40 g/min, an inlet temperature of 200° C., and an atomizer rotation number of 13,000 rpm.

When the spherical machining was not carried out, classification treatment was carried out by the following method: 100 parts of the powder and 500 parts of ethanol were mixed and dispersed with an ultrasonic disperser (ultrasonic cleaner) or the like so as to prevent the disintegration of powder particles to the greatest possible extent. After that, the dispersion liquid was passed through a sieve (mesh) having an opening diameter of 5 μm, and the remaining powder on the sieve was dried at 150° C. for 5 hours to remove a fine powder having a size of 5 μm or less generated by the crushing.

### Example 11

Further, in Example 11, treatment was carried out in the same manner as in Example 1 except that the raw material particles and slurry were prepared as described below.

First, Ni(OH)₂ powder (product of Kojundo Chemical Laboratory Co., Ltd.), Co(OH)₂ powder (product of Kojundo Chemical Laboratory Co., Ltd.), and Al₂O₃.H₂O (product of SASOL) were weighed so that the molar ratio of Ni, Co, and Al in the resultant mixture was 80:15:5. Next, to such weighed product was added a pore-forming material (spherical: product of AIR WATER INC., trade name “Bel!pearl R100”). The pore-forming material was weighed at a ratio of 8% with respect to the total weight of the powder after its addition. In addition, the mixed powder after the addition of the pore-forming material was pulverized and mixed using a ball mill for 24 hours to prepare a raw material particle powder.

100 parts of the prepared raw material particle powder, 100 parts of a dispersion medium (toluene:isopropyl alcohol=1:1 (mass ratio)), 10 parts of a binder (polyvinyl butyral: product number: BM-2, product of Sekisui Chemical Co., Ltd.), 4 parts of a plasticizer (bis(2-ethylhexyl) phthalate: synonym: dioctyl phthalate (abbreviated name: DOP), product of KUROGANE KASEI Co., Ltd.), and 2 parts of a dispersant (product name “RI-IEODOL SP-O30,” product of Kao Corporation) were mixed. Then, the mixture was stirred under reduced pressure to remove bubbles, and the viscosity was adjusted to 3 to 4 Pa·s to prepare a slurry.

Table 1 shows production conditions of Examples 1 to 11 and Comparative Examples 1 to 4 described above and Table 2 and Table 3 show the evaluation results thereof.

TABLE 1

| | | | | | Feed | | | | | |
|---|---|---|---|---|---|---|---|---|---|---|
| | | | Addition | | rate | | | | | |
| | | | amount of | | during | Rate of | | | Mesh opening | |
| | Material | Pore-forming | pore-forming | Forming | forming | temperature | | Firing | diameter | Spherical |
| | system | material | material | method | (m/s) | increase | Calcination | temperature | (μm) | machining |
| Example 1 | Ni system | Spherical | 2 | Tape | 1 | 200 | Present | 775 | 30 | Air-flow |
| | | | | forming | | | | | | classification |
| Example 2 | Ni system | Spherical | 20 | Tape | 1 | 200 | Absent | 775 | 30 | Air-flow |
| | | | | forming | | | | | | classification |
| Example 3 | Ni system | Spherical | 7 | Tape | 1 | 400 | Absent | 750 | 25 | Air-flow |
| | | | | forming | | | | | | classification |
| Example 4 | Ni system | None | — | Tape | 1 | 400 | Absent | 750 | 25 | Air-flow |
| | | | | forming | | | | | | classification |
| Example 5 | Ni system | Fibrous | 7 | Tape | 1 | 50 | Absent | 775 | 25 | Air-flow |
| | | | | forming | | | | | | classification |
| Example 6 | Ni system | Spherical | 13 | Tape | 1 | 200 | Present | 750 | 25 | Air-flow |
| | | | | forming | | | | | | classification |
| Example 7 | Ni system | Spherical | 14 | Tape | 0.1 | 50 | Absent | 750 | 25 | Air-flow |
| | | | | forming | | | | | | classification |
| Example 8 | Ni system | Spherical | 14 | Tape | 0.5 | 200 | Absent | 750 | 25 | Air-flow |
| | | | | forming | | | | | | classification |
| Example 9 | Ni system | Fibrous | 14 | Tape | 1 | 200 | Present | 750 | 25 | — |
| | | | | forming | | | | | | |
| Example 10 | Ni system | Fibrous | 13 | Tape | 1 | 200 | Present | 750 | 25 | Air-flow |
| | | | | forming | | | | | | classification |
| Example 11 | Ni system | Spherical | 8 | Tape | 1 | 50 | Absent | 750 | 25 | Air-flow |
| | | | | forming | | | | | | classification |
| Comparative | Ni system | Spherical | 7 | Tape | 1 | 50 | Present | 725 | 25 | Air-flow |
| Example 1 | | | | forming | | | | | | classification |
| Comparative | Ni system | Fibrous | 7 | Spray | — | 200 | Present | 750 | — | — |
| Example 2 | | | | drying | | | | | | |
| Comparative | Ni system | None | — | Tape | 1 | 400 | Present | 775 | 25 | Air-flow |
| Example 3 | | | | forming | | | | | | classification |
| Comparative | Ni system | Spherical | 2 | Tape | 1 | 200 | Absent | 800 | 25 | Air-flow |
| Example 4 | | | | forming | | | | | | classification |

TABLE 2

| | Powder characteristics | | | | | | | |
|---|---|---|---|---|---|---|---|---|
| | Primary | | Primary | Secondary | | Average | Average primary | |
| | grain size | Secondary | grain | grain aspect | Voidage | pore size | grain size/average | Rate of |
| | (μm) | grain size (μm) | aspect ratio | ratio | (%) | (μm) | pore size | orientation (%) |
| Example 1 | 1.1 | 17 | 1.2 | 1.2 | 4 | 1.2 | 0.9 | 75 |
| Example 2 | 1.3 | 17 | 1.3 | 1.1 | 28 | 1.3 | 1.0 | 75 |
| Example 3 | 0.8 | 14 | 1.2 | 1.1 | 11 | 5.0 | 0.2 | 75 |
| Example 4 | 0.7 | 14 | 1.1 | 1.2 | 12 | 0.2 | 3.5 | 75 |
| Example 5 | 2.5 | 16 | 1.4 | 1.2 | 10 | 1.2 | 2.1 | 75 |
| Example 6 | 0.8 | 14 | 1.2 | 1.1 | 19 | 1.1 | 0.7 | 75 |
| Example 7 | 0.7 | 13 | 1.1 | 1.1 | 20 | 1.2 | 0.6 | 90 |
| Example 8 | 0.7 | 14 | 1.2 | 1.2 | 20 | 1.1 | 0.6 | 60 |
| Example 9 | 0.8 | 13 | 1.2 | 1.4 | 20 | 1.0 | 0.8 | 75 |
| Example 10 | 0.8 | 15 | 1.2 | 1.3 | 19 | 1.8 | 0.4 | 75 |
| Example 11 | 0.8 | 14 | 1.3 | 1.2 | 11 | 0.7 | 1.1 | 75 |
| Comparative | 0.3 | 17 | 1.3 | 1.1 | 11 | 4.0 | 0.08 | 75 |
| Example 1 | | | | | | | | |
| Comparative | 0.8 | 14 | 1.2 | 1.1 | 10 | 0.7 | 1.1 | 0 |
| Example 2 | | | | | | | | |
| Comparative | 1.0 | 13 | 1.2 | 1.2 | 2 | 0.2 | 5.0 | 75 |
| Example 3 | | | | | | | | |
| Comparative | 5.0 | 15 | 1.5 | 1.3 | 5 | 0.6 | 8.3 | 75 |
| Example 4 | | | | | | | | |

TABLE 3

Cell characteristics

| | Percent rate | |
|---|---|---|
| | capacity | SOC 10% voltage |
| | maintenance (%) | (V) |
| Example 1 | 85.9 | 3.51 |
| Example 2 | 86.1 | 3.53 |
| Example 3 | 86.2 | 3.52 |
| Example 4 | 85.7 | 3.51 |
| Example 5 | 85.7 | 3.51 |
| Example 6 | 87.1 | 3.56 |
| Example 7 | 88.2 | 3.58 |
| Example 8 | 85.8 | 3.51 |
| Example 9 | 86.2 | 3.52 |
| Example 10 | 86.9 | 3.55 |
| Example 11 | 87.0 | 3.55 |
| Comparative | 83.6 | 3.44 |
| Example 1 | | |
| Comparative | 83.2 | 3.43 |
| Example 2 | | |
| Comparative | 82.9 | 3.44 |
| Example 3 | | |
| Comparative | 83.1 | 3.44 |
| Example 4 | | |

### 5-2: Ternary System Composition

### Example 12 and Comparative Example 5

In Example 12, Li(Ni_{0.33}CO_{0.33}Mn_{0.33})O₂ powder was produced by changing the weighing condition and the firing (lithium incorporation) condition during the preparation of raw material particles in Example 1 as described below. Further, Comparative Example 5 corresponded to Example 12 in which the forming method was changed to spray drying.

Ni(OH)₂ powder (product of Kojundo Chemical Laboratory Co., Ltd.), Co(OH)₂ powder (product of Kojundo Chemical Laboratory Co., Ltd.), and MnCO₃ powder (product of Tosoh Corporation) were weighed so that the molar ratio of Ni, Co, and Al in the resultant mixture was 0.33:0.33:0.33 during the preparation of raw material particles. Further, during firing (lithium incorporation), thermal treatment was carried out in an air atmosphere (0.02 MPa) at 950° C. for 12 hours.

### 5-3: Solid Solution System Composition

### Example 13 and Comparative Example 6

In Example 13, a secondary grain powder of a solid solution system was produced by changing conditions during the preparation of raw material particles in Example 1 as described below. Further, Comparative Example 6 corresponded to Example 13 in which the forming method was changed to spray drying.

An aqueous solution containing a mixture of sulfates of Ni, Co, and Mn was synthesized so that the molar ratio of Co, Ni, and Mn in the resultant mixture was 16.3:16.3:67.5, and the synthesized aqueous solution containing a mixture of sulfates was subjected to a reaction with NaOH in a hot water bath at 50° C., to thereby produce a coprecipitation hydroxide. The resultant coprecipitation hydroxide was pulverized and mixed using a ball mill for 16 hours to produce a raw material particle powder. It should be noted that, in Example 13, to such raw material particle powder, bismuth oxide (product of TAIYO KOKO CO., LTD.) was further added at a weight of 0.5 wt % with respect to the total weight after its addition (such addition of bismuth oxide was not carried out in Comparative Example 6).

Table 4 shows the production conditions of Examples 12 and 13 and Comparative Examples 5 and 6 described above, and Table 5 and Table 6 show the evaluation results thereof. It should be noted that, in Example 13 and Comparative Example 6 each using the solid solution system, “4.3 V” and “2.5 V” in the charge-discharge operations were changed to “4.8 V” and “2.0 V,” respectively, during the evaluation of the percent rate capacity maintenance.

TABLE 4

| | | | Addition | | Feed rate | | | | | |
|---|---|---|---|---|---|---|---|---|---|---|
| | | | amount of | | during | Rate of | | | Mesh opening | |
| | Material | Pore-forming | pore-forming | Forming | forming | temperature | | Firing | diameter | Spherical |
| | system | material | material | method | (m/s) | increase | Calcination | temperature | (μm) | machining |
| Example 12 | Ternary | Spherical | 15 | Tape | 1 | 200 | Absent | 850 | 25.0 | Air-flow |
| | system | | | forming | | | | | | classification |
| Comparative | Ternary | Spherical | 3 | Spray | — | 200 | Absent | 900 | — | — |
| Example 5 | system | | | drying | | | | | | |
| Example 13 | Solid | Fibrous | 10 | Tape | 1 | 200 | Absent | 900 | 25.0 | Air-flow |
| | solution | | | forming | | | | | | classification |
| | system | | | | | | | | | |
| Comparative | Solid | None | — | Tape | 1 | 200 | Present | 1,000 | 25.0 | Air-flow |
| Example 6 | solution | | | forming | | | | | | classification |
| | system | | | | | | | | | |

TABLE 5

| | Powder characteristics | | | | | | | |
|---|---|---|---|---|---|---|---|---|
| | | Secondary | | Secondary | | | Average primary | |
| | Primary grain | grain size | Primary grain | grain aspect | Voidage | Average pore | grain size/average | Rate of |
| | size (μm) | (μm) | aspect ratio | ratio | (%) | size (μm) | pore size | orientation (%) |
| Example 12 | 0.8 | 14 | 1.2 | 1.2 | 20 | 1.1 | 0.7 | 75 |
| Comparative | 1.2 | 13 | 1.3 | 1.1 | 5 | 1.0 | 1.2 | 0 |
| Example 5 | | | | | | | | |
| Example 13 | 0.2 | 12 | 1.2 | 1.3 | 25 | 1.0 | 0.2 | 75 |
| Comparative | 1.2 | 12 | 1.4 | 1.3 | 5 | 0.2 | 6.0 | 75 |
| Example 6 | | | | | | | | |

TABLE 6

| | Cell characteristics | |
|---|---|---|
| | Percent rate capacity maintenance | |
| | (%) | SOC 10% voltage (V) |
| Example 12 | 86.1 | 3.51 |
| Comparative | 82.2 | 3.43 |
| Example 5 | | |
| Example 13 | 69.5 | 2.51 |
| Comparative | 42.1 | 2.20 |
| Example 6 | | |

### 6. EXEMPLARY ENUMERATION OF MODIFICATIONS

It should be noted that the above-mentioned embodiments and specific examples are, as described above, mere exemplary embodiments of the best mode of the present invention which the applicant of the present invention has contemplated at the time of the filing of the present application. The embodiments and specific examples should not be construed as limiting the present invention in any way. Thus, as a matter of course, various modifications to the embodiments and specific examples may be made as long as an essential part of the present invention is not altered.

Hereinafter, several modifications are exemplified. In the following descriptions of the modifications, component members similar in structure and function to those of the above-mentioned embodiments are denoted by the same names and reference numerals in these modifications as well. In addition, the descriptions of the component members in the above-mentioned embodiments may be appropriately incorporated in these modifications as long as there is no inconsistency.

Needless to say, even modifications are not limited to ones described below. Limitingly construing the present invention based on the descriptions of the above-mentioned embodiments and the following modifications unfairly impairs the interests of the applicant while unfairly benefiting imitators, and is thus impermissible (particularly under the first-to-file system, which motivates filing as early as possible).

Further, needless to say, the configurations of the above-mentioned embodiments and the configurations of the following modifications are entirely or partially applicable in appropriate combination as long as there is no technical inconsistency.

The configuration of the lithium secondary battery 1 to which the present invention is applied is not limited to the above-mentioned configuration. For example, the present invention is not limited to the above-mentioned specific battery configuration. That is, for example, the present invention is also suitably applicable to the cylindrical type lithium secondary battery wound around a core. Further, the present invention is not limited to the so-called liquid type battery configuration. That is, for example, a gel electrolyte or a polymer electrolyte may be used as the electrolyte.

Any other compound may be present in the pore V. For example, when an electrolyte, a conductive material, any other lithium ion cathode active material excellent in rate characteristic, a cathode active material having a different particle size, or the like is present in the pore V, the rate characteristic or cycle characteristic is additionally improved. As a method of allowing any other compound to be present in the pore V, there are known, for example, a technique involving allowing any other compound to be present by applying the compound onto a surface of a pore-forming material in advance and then adjusting a firing condition, and a technique involving mixing the compound with a raw material particle during the forming of the cathode active material particles 222.

In addition, the surfaces of the monocrystalline primary grains 222a or the cathode active material particles 222 may be coated with any other material. Improvements in thermal stability and chemical stability of a material and an improvement in rate characteristic are achieved depending on materials to be used for the coating. As the materials to be used for the coating, for example, the following may be used: alumina, zirconia, alumina fluoride, and the like, which are chemically stable; materials such as lithium cobaltate excellent in diffusibility of lithium; and carbon excellent in electron conductivity.

FIG. 7 is a view illustrating the configuration of a modification of the cathode active material particle 222 illustrated in FIG. 3. As illustrated in FIG. 7, the orientation property of a surface layer portion in the cathode active material particle 222 may be lower than that of the inside thereof. That is, the monocrystalline primary grains 222a in the cathode active material particle 222 according to this modification may be randomly oriented only in the surface layer portion in the cathode active material particle 222.

According to such configuration, even in a region having a surface in which the (003) plane through which intercalation and deintercalation of lithium ions and electrons hardly occur is widely exposed to the outside, intercalation and deintercalation of lithium ions between the monocrystalline primary grains 222a and an electrolyte on the outer side thereof become likely to occur, thus improving a rate characteristic. Such surface layer may be formed, for example, by allowing fine powders generated during crushing or spherical machining to adhere to particles again (this can be achieved by appropriately adjusting the conditions for the crushing or the spherical machining). It should be noted that such intraparticle fine structure may be evaluated, for example, by subjecting a cross-section (processed with a cross section polisher, a focused ion beam, or the like) of a secondary grain to electron backscatter diffractometry (EBSD) in SEM observation or crystal orientation analysis in TEM observation.

The present invention is by no means limited to the specific production method described above. For example, the forming method is not limited to the method described above. Further, the firing (lithium incorporation) step described above may be omitted by appropriately selecting raw materials before forming.

In addition, even in the case of using oxides as the raw material particles, the cathode active material precursor material particle 704 in which the raw material particles are oriented (filled with their crystal orientations being aligned with each other) may be obtained, for example, by allowing a magnetic field to act during forming. Thus, the present invention is not limited to the case of using hydroxides as the raw material particles.

In addition, needless to say, a modification which is not particularly mentioned herein is also encompassed in the technical scope of the present invention as long as an essential part of the present invention is not altered.

Further, the component members of the means for solving the problems of the present invention, which are illustrated with respect to operations and functions, encompass not only the specific structures disclosed in the descriptions of the above-mentioned embodiments and modifications but also any other structure that can realize the operations and functions. Further, the contents (including specifications and drawings) of the prior application and publications cited herein can be appropriately incorporated herein as appropriate by reference as components of the specification.

1. A cathode active material for a lithium secondary battery having a layered rock salt structure, comprising a secondary grain formed of a large number of primary grains each having an average grain size of 0.01 μm or more and 5 μm or less, wherein the secondary grain has:
a (003) plane orientation degree of 60% or more;
an average grain size of 1 μm or more and 100 μm or less;
an aspect ratio, which is a value obtained by dividing a long axis size by a short axis size, of 1.0 or more and less than 2;
a voidage of 3% or more and 30% or less;
an average pore size of 0.1 μm or more and 5 μm or less; and
a value obtained by dividing the average grain size of each of the primary grains by the average pore size of 0.1 or more and 5 or less.

2. A cathode active material for a lithium secondary battery according to claim 1, wherein the rate of orientation is 75% or more.

3. A cathode active material for a lithium secondary battery according to claim 1, wherein the secondary grain has the aspect ratio of 1.1 or more and 1.5 or less.

4. A lithium secondary battery, comprising a cathode including a cathode active material layer and an anode including an anode active material layer,
wherein:
the cathode active material layer comprises a cathode active material formed as a secondary grain including an assembly of a plurality of monocrystalline primary grains of a lithium composite oxide having a layered rock salt structure,
the primary grains each have an average grain size of 0.01 μm or more and 5 μm or less; and
the secondary grain has:
a (003) plane orientation degree of 60% or more;
an average grain size of 1 μm or more and 100 μm or less;
an aspect ratio, which is a value obtained by dividing a long axis size by a short axis size, of 1.0 or more and less than 2;
a voidage of 3% or more and 30% or less;
an average pore size of 0.1 μm or more and 5 μm or less; and
a value obtained by dividing the average grain size of each of the primary grains by the average pore size of 0.1 or more and 5 or less.

5. A lithium secondary battery according to claim 4, wherein the rate of orientation is 75% or more.

6. A lithium secondary battery according to claim 4, wherein the secondary grain has the aspect ratio of 1.1 or more and 1.5 or less.

7. A cathode active material for a lithium secondary battery according to claim 2, wherein the secondary grain has the aspect ratio of 1.1 or more and 1.5 or less.

8. A lithium secondary battery according to claim 5, wherein the secondary grain has the aspect ratio of 1.1 or more and 1.5 or less.
